(19) United States
(12) Patent Application Publication
(10) Pub. No.: US 2009/0029310 A1
(43) Pub. Date: Jan. 29, 2009

(54) DENTAL MODELS AND SERIES OF DENTAL MODELS, AND METHODS AND APPARATUS FOR MAKING AND USING SAME

(75) Inventors: Willis J. Pumphrey, Houston, TX (US); Paul Dinh, Houston, TX (US)

Correspondence Address: GILBRETH & ASSOCIATES, P.C., PO BOX 2428, BELLAIRE, TX, 77402-2428, US

(73) Assignee: Clearcorrect, Inc., Houston, TX (US)

(21) Appl. No.: 12/037,878

(22) Filed: Feb. 26, 2008

Related U.S. Application Data
(60) Provisional application No. 60/903,642, filed on Feb. 26, 2007.

(51) Int. Cl. A61C 7/00

(52) U.S. Cl. 433/24

(57) ABSTRACT

Methods of making a series of dental models, as well as devices and systems for making a series of dental models, are described. In general, these methods and systems describe a manual and visual method of manipulating tooth models to form the series of digital models. Also described are methods for packing, distributing and using a series of dental models, and methods for editing and storing dental models.

### REFERENCE TO RELATED APPLICATIONS

The application claims priority of U.S. Provisional Patent Application No. 60/903,642, filed Feb. 26, 2007, which is herein incorporated by reference.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND OF THE INVENTION

1. Field of the Invention

The present invention relates to dental models and series of dental models, and to methods and apparatus for making and using same.

2. Description of the Related Art

A dental model (or “dental arch model”) shows the arrangement of a subject's teeth in a dental arch. A dental model may show the actual arrangement of a subject's teeth, however in some cases it may be useful to make models in which the teeth are moved from their actual arrangement. Such models may help visualize possible re-arrangements of a subject's teeth. In some applications, a dentist or orthodontist may use a dental model to examine how a subject's teeth would look after orthodontic treatment. In addition, dental models may be used to help design dental treatments.

In another application, dental models in which a subject's teeth are displaced slightly from their actual arrangement can be used to make dental appliances (including aligners) to help move the teeth into a new arrangement. Orthodontists may make plaster models of a subject's upper and lower dental arch, cut the model into separate tooth models, and arrange these tooth models into a wax bed in a desired arrangement (referred to as a dental set-up). The re-arranged dental set up may then be used to design an aligner or a bracket to be applied to a subject's teeth to move the teeth towards the re-arranged position. In this manner, teeth may be incrementally moved from an initial position into a new (e.g., more aligned) position by creating an entire series of dental models or dental set-ups. The way in which teeth are repositioned in each incrementally re-arranged dental set-up is therefore critical. In particular, the step of re-arranging the teeth from an actual arrangement of the subject's teeth into a new arrangement must be done carefully so that the teeth are not moved too far, or moved in a way that would interfere with later movements or dental function.

It is generally believed that manually rearranging tooth models to produce a new dental arch model is not sufficiently accurate to be useful in making the precise “incremental” movements optimal for repositioning a subject's teeth. As a result, complex and expensive digital models of teeth and the dental arch have been relied on to make dental appliances for moving teeth. Typically, this has involved the creation of large data sets, and the use of computer-intensive methods of making digital models of the teeth and/or dental arch.

U.S. Pat. No. 5,431,562, issued Jul. 11, 1995 to Andreiko et al., discloses a system and method by which an orthodontic appliance is automatically designed and manufactured from digital lower jaw and tooth shape data of a patient, and provides for preferably scanning a model of the patient's mouth to produce two or three dimensional images and digitizing contours and selected points. A computer is programmed to construct archforms and calculate finish positions of the teeth, then to design an appliance, preferably including archwires and brackets, to move the teeth to the calculated positions. The lower teeth are positioned at their roots on an arch defined by the lower jaw bone, and the arch is modified to best fit the tooth tips on a smooth curve. Then upper archforms are constructed for the upper teeth. Crown long axes of the teeth are derived and preserved in the treatment which places all lower teeth but the cuspids in a plane and fits the occluding teeth to them. Overlaps for the upper incisors and for cuspid rise are calculated.

U.S. Pat. No. 6,699,037, issued Mar. 2, 2004, to Chishti et al., discloses a system for repositioning teeth that comprises a plurality of individual appliances. The appliances are configured to be placed successively on the patient's teeth and to incrementally reposition the teeth from an initial tooth arrangement, through a plurality of intermediate tooth arrangements, and to a final tooth arrangement. The system of appliances is usually configured at the outset of treatment so that the patient may progress through treatment without the need to have the treating professional perform each successive step in the procedure.

Most of these digital modeling methods require the creation of digital data sets to represent the teeth and the arrangement of teeth, and are computer-intensive. In addition, most previously described methods require additional systems and devices for either directly using the digital dental models to form dental appliances or they require translation of the digital dental models into a physical model.

U.S. Pat. No. 6,722,880, issued Apr. 20, 2004, to Chishti et al., discloses a system for repositioning teeth comprises a plurality of individual appliances. The appliances are configured to be placed successively on the patient's teeth and to incrementally reposition the teeth from an initial tooth arrangement, through a plurality of intermediate tooth arrangements, and to a final tooth arrangement. The system of appliances is usually configured at the outset of treatment so that the patient may progress through treatment without the need to have the treating professional perform each successive step in the procedure.

U.S. Pat. No. 7,037,111, issued May 2, 2006, to Miller, discloses devices, systems and methods for producing dental molds, each having portions representing a patient's oral soft tissue and a desired tooth configuration. These molds are designed for use in the fabrication of appliances used in orthodontic treatment, particularly, elastic repositioning appliances. However, they may also be used in the fabrication of traditional appliances, such as retainers and positioners, used, for example in the final or finishing stages of an otherwise conventional treatment. The dental molds are comprised of a mold or relief of the patient's soft tissue, such as a palate, facial gingival tissue and/or lingual gingival tissue, and a separate or separable mold or relief of the patient's dental arch having teeth in a desired tooth configuration. Since, the tooth configuration will change as a patient progresses through orthodontic treatment, the relief of the dental arch will be fabricated separately from the relief of the oral soft tissue. Typically, the dental arch relief will be fabricated using rapid prototyping methods. The soft tissue relief may also be fabricated using rapid prototyping, however it may also be fabricated using traditional mold making methods, i.e., casting with plaster or other mold making materials. In either case, the resulting dental mold with be comprised of a “split-mold” having fixedly or removably joined arch and soft tissue reliefs.

U.S. Pat. No. 6,210,162, issued Apr. 3, 2001, to Chishti et al., discloses a positive mold for use in creating an orthodontic appliance is produced by obtaining a digital dentition model, such as a 3D geometric surface model or a 3D volumetric image model, that defines the shape of an orthodontic appliance and then altering the digital dentition model to remove a portion that does not affect the shape of the orthodontic appliance. The altered digital dentition model then is used to construct a positive mold for the orthodontic appliance. Processing circuitry, such as a programmed computer, is used to obtain and alter the digital dentition model. A rapid prototyping device, such as a stereolithography machine, is commonly used to construct the positive mold.

U.S. Pat. No. 6,217,325, issued Apr. 17, 2001, to Chishti et al., discloses a system for repositioning teeth comprises a plurality of individual appliances. The appliances are configured to be placed successively on the patient's teeth and to incrementally reposition the teeth from an initial tooth arrangement, through a plurality of intermediate tooth arrangements, and to a final tooth arrangement. The system of appliances is usually configured at the outset of treatment so that the patient may progress through treatment without the need to have the treating professional perform each successive step in the procedure.

U.S. Pat. No. 6,227,851, issued May 8, 2001, to Chishti et al., discloses a manipulable or reconfigurable dental model system and methods for its use to model a series of tooth configurations corresponding to sequential tooth movements during an orthodontic treatment. When a patient undergoes orthodontic treatment, teeth and bite configurations are realigned in a series of stages. Each stage represents a new pattern or dental configuration that will eventually lead to a proper final positioning of the entire dentition. Progress from the initial configuration, through the intermediate stages and finally to the final configuration may be accomplished using any one or a combination of different dental appliances. Of particular interest to the present invention, many of these appliances may be made using a dental mold representing the patient's dental configuration. In particular, thermoformable plastic positioning appliances which fit over the patient's teeth may be formed over a three-dimensional mold of the patient's dentition. When successive appliances are used throughout treatment to reposition the teeth from initial to final configuration, a new mold has typically been produced to fabricate the appliance for each stage. The present invention provides an apparatus and methods which employ a manipulable or reconfigurable mold to model patient dentition and gingiva at each stage of treatment.

U.S. Pat. No. 6,309,215, issued Oct. 30, 2001, to Phan et al., discloses systems and methods for removably attaching a dental positioning appliance to the dental features of a patient during orthodontic treatment. Such removable dental positioning appliances are often preferred over conventional braces for tooth repositioning due to comfort, appearance and ease of use. These appliances function by applying force to specific surfaces of the teeth or dental features to cause directed movement. However, the type of movement and level of force applied is usually dependent on the surface characteristics and positions of the dental features. In many cases, these aspects are inadequate to provide sufficient anchoring or to impart considerable force on the teeth to be repositioned. Such limitations may be diminished with the use of one or more attachment devices which may be positioned on the teeth or dental features to provide the appropriate physical features. Specific design and location of these attachment devices may provide newly achievable and/or more effective repositioning forces, anchoring ability and appliance retention. The systems and methods of the present invention provide the design, production and use of such attachment devices with removable dental positioning appliances in orthodontic treatment.

U.S. Pat. No. 6,499,997, issued Dec. 31, 2002, to Chishti et al., discloses manipulable or reconfigurable dental model system and methods for its use to model a series of tooth configurations corresponding to sequential tooth movements during an orthodontic treatment.

U.S. Pat. No. 6,629,840, issued Oct. 7, 2003, to Chishti et al., discloses a system for repositioning teeth comprises a plurality of individual appliances. The appliances are configured to be placed successively on the patient's teeth and to incrementally reposition the teeth from an initial tooth arrangement, through a plurality of intermediate tooth arrangements, and to a final tooth arrangement. The system of appliances is usually configured at the outset of treatment so that the patient may progress through treatment without the need to have the treating professional perform each successive step in the procedure.

U.S. Pat. No. 6,685,469, issued Feb. 3, 2004, to Chishti et al., discloses an apparatus and method define a fit a set of upper and lower teeth in a masticatory system of a patient by generating a computer representation of the masticatory system of the patient; and determining an occlusion from the computer representation of the masticatory system using one or more keys.

U.S. Pat. No. 6,964,564, issued Nov. 15, 2005, to Phan et al., discloses devices, systems and methods for repositioning teeth from an initial tooth arrangement to a final tooth arrangement. Repositioning is accomplished with a system comprising a series of polymeric shell appliances configured to receive the teeth and incrementally reposition individual teeth in a series of successive steps. The individual appliances may be formed from layers having different stiffnesses (elastic moduluses), and the stiffnesses of successive appliances may be different, or both.

U.S. Pat. No. 7,092,784, issued Aug. 15, 2006, to Simkins, discloses a method producing an object using thermal-forming by positioning a die representative of the object in a chamber; positioning a sheet of material over the die; pressurizing the chamber; and delivering a beam of energy over the sheet and the die to form the object.

U.S. Pat. No. 6,705,863, issued Mar. 16, 2004, to Phan et al., discloses systems and methods for removably attaching a dental positioning appliance to the dental features of a patient during orthodontic treatment.

U.S. Pat. No. 6,830,450, issued Dec. 14, 2004, to Knopp et al., discloses a system and method for repositioning teeth in a patient jaw includes an attachment bonded to a tooth. The attachment has at least one force receiving component for receiving a force. A polymeric shell repositioning appliance is positioned over at least some of the teeth in the patient jaw. The polymeric shell has at least one force transmitting component for engaging the force receiving component to form a locus of engagement. The locus of engagement transmits the force and moves but is maintained as the tooth is repositioned. In specific embodiments the locus of engagement is maintained over a substantial range of motion. The force transmitted at the locus of engagement increases in response to the tooth lagging an intended position. A space between the positioned appliance and the tooth permits the tooth to move into an intended position.

U.S. Pat. No. 6,309,215, issued Oct. 30, 2001, to Phan et al., discloses systems and methods for removably attaching a dental positioning appliance to the dental features of a patient during orthodontic treatment.

U.S. Pat. No. 6,390,812, issued May 21, 2002, to Phan discloses an improved dental appliance system, and methods for using and fabricating the improved appliance, including a polymeric overlay or shell having a teeth-receiving cavity formed therein. The dental appliance having the necessary stiffness or strength to firmly secure the appliance on the teeth and provide controlled forces required for repositioning the teeth, until such time as removal of the appliance is desired. The appliance may be configured for use with a removal mechanism. The removal mechanism provides for selective rel ease of the appliance from the teeth as the removal mechanism undergoes a state change stimulated by an environmental stimulus or environmental switch.

### SUMMARY OF THE INVENTION

According to embodiment of the present invention, there is provided a method of making a series of dental models. The method may include one or more steps of positioning tooth models within a positioner in a first tooth arrangement, viewing the tooth arrangement and a visual reference guide, and manually moving one or more of the tooth models with reference to the visual reference guide, to position the tooth models within the positioner in a second tooth arrangement.

According to another embodiment of the present invention, there is provided an apparatus for producing a series of dental models. The apparatus may include a positioner configured to hold an arrangement of tooth models and permit manual movement of the tooth models, a camera configured to view the arrangement of tooth models within the positioner, a display configured to display an image of the arrangement of tooth models viewed by the camera, and/or a visual reference guide configured to track movements of teeth within the positioner.

According to even another embodiment of the present invention, there is provided an apparatus for producing a series of dental models. The apparatus may include a positioner for holding an arrangement of tooth models, a plurality of cameras configured to view the arrangement of tooth models within the positioner, a display configured to display an image of the arrangement of tooth models viewed by at least one of the cameras, and a visual reference guide applied to the image of the arrangement of the tooth models, the visual reference guide configured to track manual movements of teeth within the positioner.

According to still another embodiment of the present invention, there is provided a method of providing a series of positive dental models. The method may include at least one of producing a series of dental models comprising at least a first dental model, a second dental model, and a third dental model, wherein the dental models represent at least a portion of a subject's dental arch, and wherein at least one tooth in the second dental model is in an incrementally different position in the first dental model, and further wherein at least one tooth in the third dental model is in an incrementally different position in the second dental model; and/or delivering the series of dental models to a dental practitioner.

According to yet another embodiment of the present invention, there is provided a method of providing a series of positive dental models. The method may include receiving a model of a subject's dental arch from a dental practitioner, producing a series of positive dental models comprising at least a first dental model, a second dental model, and a third dental model, wherein at least one tooth in the first dental model is in an incrementally different position than the corresponding tooth in the model of the subject's dental arch received from the practitioner, and wherein at least one tooth in the second dental model is in an incrementally different position in the first dental model, and further wherein at least one tooth in the third dental model is in an incrementally different position in the second dental model, and delivering the series of dental models to the dental practitioner.

Some of the embodiments above, and/or some portions of the embodiments above may apply to digital dental models in addition to physical dental models.

### BRIEF DESCRIPTION OF THE DRAWINGS

The following drawings illustrate some of the many possible embodiments of this disclosure in order to provide a basic understanding of this disclosure. These drawings do not provide an extensive overview of all embodiments of this disclosure. These drawings are not intended to identify key or critical elements of the disclosure or to delineate or otherwise limit the scope of the claims. The following drawings merely present some concepts of the disclosure in a general form. Thus, for a detailed understanding of this disclosure, reference should be made to the following detailed description, taken in conjunction with the accompanying drawings, in which like elements have been given like numerals.

FIG. 1 shows one example of a dental model as described herein.

FIG. 2 illustrates one embodiment of a method for making a series of dental models

FIG. 3A and FIG. 3B show embodiments of positioners and visual reference guides.

FIG. 4 shows one embodiment of a system for making a series of dental models.

FIGS. 5A and 5B are embodiments of engagers that may be used to secure an aligner to a subject's teeth.

FIG. 5C is a portion of a tray having a cut-out region for mating with an engager.

FIG. 6 is an impression of a subject's dental arch.

FIG. 7 is a positive model of the arch shown in FIG. 6.

FIGS. 8, 9 and 10 illustrates the formation of a positioner from the arch model of FIG. 7.

FIG. 11 illustrates moving a tooth within the positioner.

FIG. 12 shows the use of the positioner to create tooth models.

### DETAILED DESCRIPTION OF THE INVENTION

Described herein are dental models and series of dental models, and methods of making and using dental models and series of dental models. Some embodiments of the methods and apparatus described herein may not require digitally modeling the subject's teeth. Some embodiments of the methods described herein may be performed either completely or partially manually. Some embodiments of the methods and apparatus may provide a relatively inexpensive and conceptually accessible alternative to currently available methods and apparatus for making dental models or dental appliances based on dental models. Some embodiments relate to physical dental models and/or digital dental models. Some of the embodiments, and/or some portions of the embodiments of the present invention, will also have application to digital dental models.

In general, dental models include a plurality of positive or negative models (physical models) representing a subject's dental arch in which the teeth are arranged in various configurations. For example, one of the dental models may be configured so that the teeth are arranged in the same position as the subject's actual teeth (before beginning the particular dental treatment), and other dental models in the series reflect actual or hypothetical positions of the subject's teeth as they are altered during a course of the particular treatment. Thus, a series of dental models may be used to predict the movement of teeth during an entire course of treatment. A series of dental models may include any appropriate number of two or more dental models as may be required for a particular or proposed course dental treatment. As non-limiting examples, a series may have three or more models, five or more models, ten or more models, or the like. Furthermore, the dental models in the series may be marked with any suitable indicia to indicate the order of dental models, reflecting the sequential order of the models as teeth are moved from the first model of the series to the last model of the series.

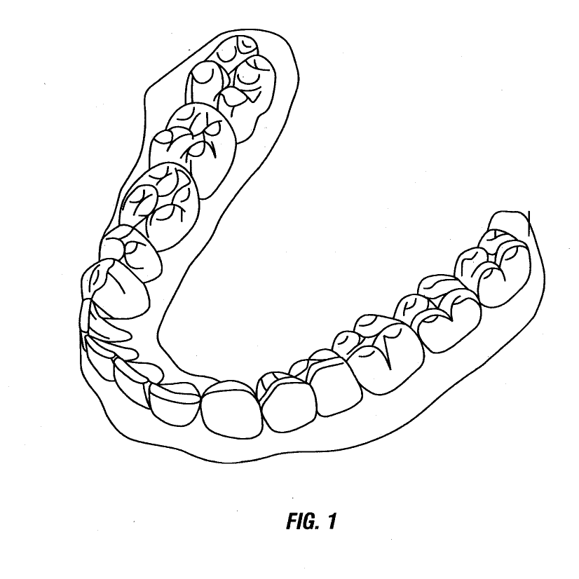

A dental model may be any appropriate representation of all or a portion of a subject's teeth and/or dental arch. Thus, a dental model may be a negative model (e.g., an impression representing at least a portion of a subject's dental arch), or a positive model. A dental model may also be a cast of the subject's teeth. A dental model may be made of any appropriate material, natural occurring or man made. Non-limiting examples of suitable materials (or combinations of materials) that can be used to form the dental models described herein may include polymer, plaster, stone, clay, metal, wood, paper, ceramic, porcelain, composites, dough like materials (see, U.S. Pat. No. 7,083,413), and any combinations thereof. As non-limiting examples, suitable polymer materials may include natural or synthetic polymeric materials, whether thermoplastic or thermoset materials. In some embodiments, relatively stiff materials may be used, although soft or compliant materials (e.g., silicones, rubbers, etc.) may also be used. In some embodiments, the dental models are urethane (e.g., polyurethane) models. FIG. 1 shows one example of a dental model. The dental model typically includes at least some of the teeth, mounted in a base region (which may also represent a portion of the subject's gums or other regions of the subject's mouth). In some embodiments, the dental model may reflect only the teeth, rather than the teeth and gums. In some embodiments, the dental model may include only the upper (e.g., crown) portions of the subject's teeth. Additionally, the present invention may have some applicability to digital dental models.

Two or more dental models may form a series of dental models. In general, a series of dental models refers to any number of two or more dental models that are related. In general, a series of dental models are related by sequence. For example, a series of dental models may show or describe sequential tooth movements, generally with respect to treatment time, meaning that one dental model is “earlier” than another dental model in sequence so that the earlier model differs from later dental models in that one or more teeth in the earlier dental model is moved by an incremental amount in a subsequent later dental model. The incremental amount is typically a pre-determined amount (e.g., less than 2 mm) in one direction, including tilt or rotation, although the incremental amount may also be a variable amount. Thus, in some embodiments, a series of dental models refers to three or more dental models that show a progression of tooth movements. Although the same teeth are typically represented in all of the models of a series of dental models, teeth may be removed between members of a series of dental models (e.g., signifying an extraction). Typically, changes in the position (or even shape) of a tooth in an earlier dental model in a series are propagated in later dental models in the sequence, as the series of dental models progresses.

Also described herein are apparatus for producing a series of dental models. An apparatus for producing a series of dental models may include a positioner (physical or digital) configured to hold an arrangement of tooth models and to permit manual movement of the tooth models, an image capture device configured to view the arrangement of tooth models within the positioner, a display configured to display an image of the arrangement of tooth models viewed by the image capture device, and a visual reference guide configured to track movements of teeth within the positioner. The visual reference guide may be configured to appear on the display of the image of the arrangement of tooth models viewed by the camera. For example, the visual reference guide may comprise a grid, concentric geometric shapes, or shading/color.

In some embodiments, the system also includes a recorder configured to record movements of the teeth within the positioner. As mentioned previously, the recorder may be a camera (including a digital camera), a video camera, or any other digital recorder. In some embodiments the recorder comprises an information handling system.

The apparatus for producing a series of dental models may also include an information handling system configured to track the movements of the teeth using the visual reference guide. Thus, this information handling system, may track and record tooth movements, particularly with respect to coordinates of the visual reference guide. A record of the movement of the teeth may be saved. In addition images showing the movements of the tooth models may be saved.

For purposes of this disclosure, an embodiment of an Information Handling System (IHS) may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an IHS may be a personal computer, a network storage device, or any other suitable device and may vary in size, shape, performance, functionality, and price. The IHS may include random access memory (RAM), one or more processing resources such as a central processing unit (CPU) or hardware or software control logic, ROM, and/or other types of nonvolatile memory. Additional components of the IHS may include one or more disk drives, one or more network ports for communicating with external devices as well as various input and output (I/O) devices, such as a keyboard, a mouse, and a video display. The IHS may also include one or more buses operable to transmit data communications between the various hardware components.

Also described are apparatus for producing a series of dental models that include a positioner for holding an arrangement of tooth models, a plurality of cameras configured to view the arrangement of tooth models within the positioner, a display configured to display an image of the arrangement of tooth models viewed by at least one of the cameras, and a visual reference guide applied to the image of the arrangement of the tooth models, the visual reference guide configured to track manual movements of teeth within the positioner. The system may also include an information handling system configured to track movement of the tooth models using the movement guide and further configured to provide feedback on manual movement of the tooth models.

In general, the methods of making a series of dental models described herein are visual methods. These visual methods may be primarily manual (e.g., involving manual manipulation and/or observation), or partially manual (e.g., using computer or machine guidance. These manipulation methods may be applied to both physical dental models and physical dental models.

The methods of making a series of physical or digital dental models may include positioning tooth models within a physical or digital positioner (the digital positioner may just be the digital environment) so that the teeth are in a first tooth arrangement (e.g., reflecting the actual arrangement of the subject's teeth, or some starting point). The methods may include viewing/comparing the teeth and a visual reference guide that indicates the relative positions of the teeth and shows how far the teeth have moved, or can be moved. The methods may also include the step of manually moving one or more of the teeth in the positioner with reference to the visual reference guide. For the digital models, the visual reference guide may also merely provide a numerical output of the position of the tooth, or how far it is off. Teeth are typically incrementally moved, and the visual reference guide helps the technician or practitioner to move manually the teeth by a desired amount. Once one or more teeth have been incrementally moved, a dental model may be made based on the arrangement of teeth in the positioner. This method of forming a series of dental models, including alternatives and embodiments, is described in more detail below.

In general, the methods of making a series of dental models described herein include manual movement of the teeth within a positioner, using a visual reference guide that reflects how far (and in what direction) a tooth is moving. For example, a method of making a series of dental models may include the steps of (a) positioning tooth models (e.g., representing the subject's teeth) within a positioner in a first tooth arrangement, (b) viewing or comparing both the tooth arrangement and a visual reference guide (so that movements of the tooth models can be tracked by the visual reference guide), and/or (c) manually moving one or more of the tooth models with reference to the visual reference guide. Again, this can be carried out both with physical and digital models. One or more tooth models are thus manually arranged within the positioner in a second tooth arrangement. In some embodiments, the positioner is a master model, in which the teeth are controllably and selectably movable. Steps (b) and (c) can be repeated as many times as necessary to produce each new model in the series of dental models. In addition, after the tooth models have been arranged into the new arrangement, a negative impression of the teeth in the new tooth arrangement can be made, and a positive model of the second tooth arrangement can then be made (e.g., by casting) from the negative model.

Any appropriate visual reference guide may be used. In general, a visual reference guide may include any suitable type of reference, non-limiting examples of which include parallel lines, radial lines, circles, concentric geometric shapes, shading/colors, and the like. As a non-limiting example, a visual reference guide may comprise a rectangular grid, or radial lines in combination with concentric geometric shapes. In some embodiments, the visual reference guide is calibrated. As a non-limiting example, the lines making up the visual reference guide may be separated by a known distance or angle. Multiple visual reference guides may be used. For example, multiple visual reference guides may be used as the positioner and tooth models are viewed at different angles.

A positioner holds the tooth models in position, but allows modification of the position of the tooth models within the positioner. Generally, the tooth will be removably attached to the positioner, and any suitable methods and apparatus for removably attaching the tooth to the positioner may be utilized. As a non-limiting example, a positioner may include a holder having wax or other pliable or selectively malleable material. The positioner may be a master model that includes models of the subject's individual teeth that are positionable therein. A mechanical holder may also be used. Other types of holders are described herein, and known to those of skill in the art. The tooth models that are placed in the positioner may be cut from a positive model of the subject's actual teeth (particularly the crown portion). The step of positioning the tooth models in a first tooth arrangement may include using a negative impression of the subject's dental arch (e.g., reflecting the actual dental arch configuration) to position the tooth models in the positioner into the first tooth arrangement.

In some embodiments, the step of viewing the tooth models with a visual reference guide includes viewing the tooth models using one or more image capture devices to form an image of the first tooth arrangement. The tooth models may be visualized “on” or “against” the visual reference guide so that movements of the tooth models can be observed and tracked. In some embodiments, the visual reference guide is incorporated as part of the positioner. In some embodiments, the visual reference guide is applied onto the tooth models (and/or the positioner). As a non-limiting example, the method of making a series of dental models may include a step of also overlaying a visual reference guide onto an image of the first tooth arrangement.

Movement of the tooth models may be visually tracked. Thus, the method of making a series of tooth models may include the step of tracking the movement of the tooth models with respect to the visual reference guide. The step of tracking the movement may include recording the movement of the tooth models. Movement may be recorded manually or using a device such as a camera (e.g., video camera) or other digital device (e.g., an information handling system). Furthermore, the method of making a series of dental models may include providing feedback on the manual movements of the tooth models. Feedback may indicate that a movement has gone too far, not far enough, or the correct distance (e.g., with respect to a pre-set parameter for incremental movement) in one or more directions. Feedback may also just be a measure of the distance, in length or percentage, that a tooth has been moved with respect to one or more of the visual reference guides. In some embodiments, a computer provides feedback on the manual movement of the tooth models based on the visual reference guide.

Also described herein are methods of providing a series of positive dental models. These methods may include producing a series of dental models comprising at least a first and second dental models, and may further comprise at least a third dental model. The methods may further include packaging the series of dental models. The methods may further include distributing the series of dental models. The methods may further include delivering the series of dental models to a dental practitioner. These dental models may represent at least a portion of a subject's dental arch, and at least one tooth in the second dental model is in an incrementally different position than in the first dental model, and further at least one tooth in the third dental model is in an incrementally different position than in the second dental model. The series of dental models distributed by this method may be any appropriate material as discussed herein.

The method of providing a series of positive dental models may also include marking the models in the series of dental arch models to indicate the sequential order of a model within the series of dental arch models. In some embodiments, the method also includes delivering a record of the movements indicating the difference in positions between teeth in the series of dental models. The record of movements may include written instructions or descriptions indicating movements or other tooth modifications (e.g., including modifications to the shape or size of the teeth or addition of elements such as engagers). In general, the record is a written record describing the tooth movements and/or modifications. The written record may include graphics (non-animated graphics), numeric, alphabetic, or symbolic descriptors. For example, the written record may describe the movement of specific teeth (“upper right 3”), movement (“rotated”/“translated”), direction (“lingually”/“distally”) and amount (“0.5 mm”).

In some embodiments, the methods of producing a series of dental models may include one or more of the steps of positioning tooth models within a positioner, sequentially forming positive dental arch models by manually moving one or more of the tooth models in the positioner with reference to a visual reference guide into a tooth arrangement, and/or making a positive dental arch model of the tooth arrangement.

Also described herein are methods of providing a series of positive dental models, including the steps of receiving a model of a subject's dental arch from a dental practitioner, producing a series of positive dental models comprising at least a first dental model, a second dental model, and a third dental model, and delivering the series of dental models to the dental practitioner. The at least one tooth in the first dental model may be in an incrementally different position than the corresponding tooth in the model of the subject's dental arch received from the practitioner, and at least one tooth in the second dental model may be in an incrementally different position than in the first dental model, and further at least one tooth in the third dental model may be in an incrementally different position than in the second dental model. The method may also include the step of marking the series of dental arch models to indicate the sequential order of the models within the series of dental arch models. The method may also include delivering a written record of tooth movements indicating the movement of teeth within the series of dental models.

In some embodiments, the methods of producing a series of dental models may include one or more steps of separating a positive model of the subject's dental arch into separate tooth models, positioning the tooth models within a positioner, and/or sequentially forming positive dental arch models by manually moving one or more of the tooth models in the positioner with reference to a visual reference guide, and making a positive dental arch model of the teeth after moving them.

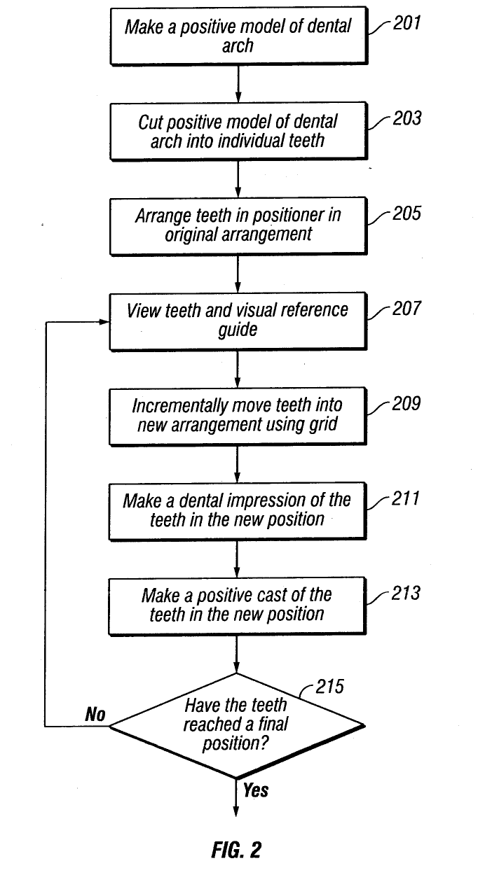

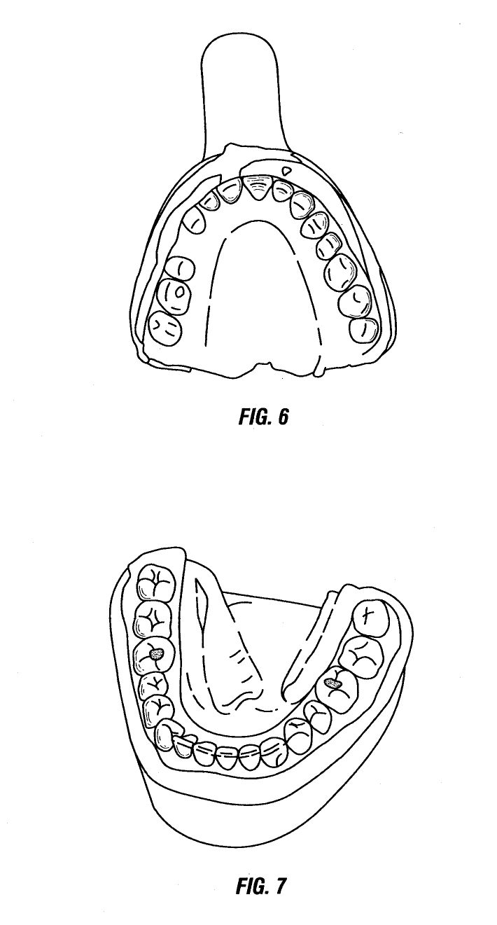

Referring now to FIG. 2 there is flowchart illustrating one non-limiting embodiment of a method for making a series of dental models. The boxes shown in FIG. 2 represent “steps” each of which may include one or more actions. Before making the series of models using this method, a positive model of the subject's actual dental arch (or a portion of the subject's dental arch) is divided up into separate tooth models. For example, a dental practitioner (e.g., dentist, orthodontist, dental technician, or the like) may take a negative impression of the subject's teeth. The negative impression may be provided, and a positive impression of the subject's teeth may then be made (step 201) from the negative impression. Referring additionally to FIG. 6, there is shown a negative impression of one portion of a subject's dental arch (e.g., the upper arch). A positive impression of the subject's teeth may be made by using the negative impression to mold the positive impression. Referring additionally to FIG. 7 there is shown a positive arch model made from the impression shown in FIG. 6. Although standard methods of taking negative impressions of the teeth and forming positive molds from them are well known, in the practice of the invention, any suitable technique may also be used to form positive and/or negative impression of the teeth or to provide a model of the subject's initial tooth arrangement. For example, digital techniques (including information handling system controlled methods such as CNC manufacturing, lithography, etc.) may also be used to provide negative and/or positive models of the subject's teeth. This positive impression may also be referred to as a positive model of the subject's initial tooth arrangement, or the actual or initial dental arch arrangement.

The initial positive dental arch model may then be divided up into separate tooth models (step 203). As a non-limiting example, the positive dental arch model may be cut to separate individual teeth from a positive impression of the subject's teeth. Individual tooth models may be separated so that each tooth model reflects a single tooth (e.g., incisor, bicuspid, etc.) corresponding to each crown portion of a subject's tooth. In some embodiments, multiple teeth (e.g., two or more adjacent teeth) may be combined in a single unit, and thus an “individual” tooth model may include multiple teeth that would be moved or positioned together. Portions of the tooth models may be specifically shaped or trimmed, particularly any non-crown region of a tooth. As a non-limiting example, the base of the model may be trimmed or cut into a shape that enhances the placement of the tooth model into a positioner. In some embodiments, the tooth may include a linker or attachment to connect the tooth model to the positioner. Additional material (e.g., linkers or attachments) may also be added to the tooth model to enhance placement in the positioner.

After dividing the positive model into separate tooth models, the tooth models may be placed into a positioner. A positioner typically ho Ids the teeth in position securely, but also allows the controlled movement of the tooth models. As a non-limiting example, a positioner may be a wax holder. The separate tooth models may be partially embedded in the wax holder (positioner) so that they are held into position. The position (including the orientation) of the teeth models may be adjusted manually by applying gentle pressure to move the teeth within the wax. In addition to wax holders, other positioners that both secure the tooth models and allow limited movement of the teeth may be used. For example, a malleable or rigidizable material may be used, including (in addition to waxes) gums, clays, or the like. Mechanical positioners may also be used. For example, a framework for holding tooth models may include articulating connectors that allow each tooth model to move with respect to other tooth models (e.g., in multiple degrees of freedom).

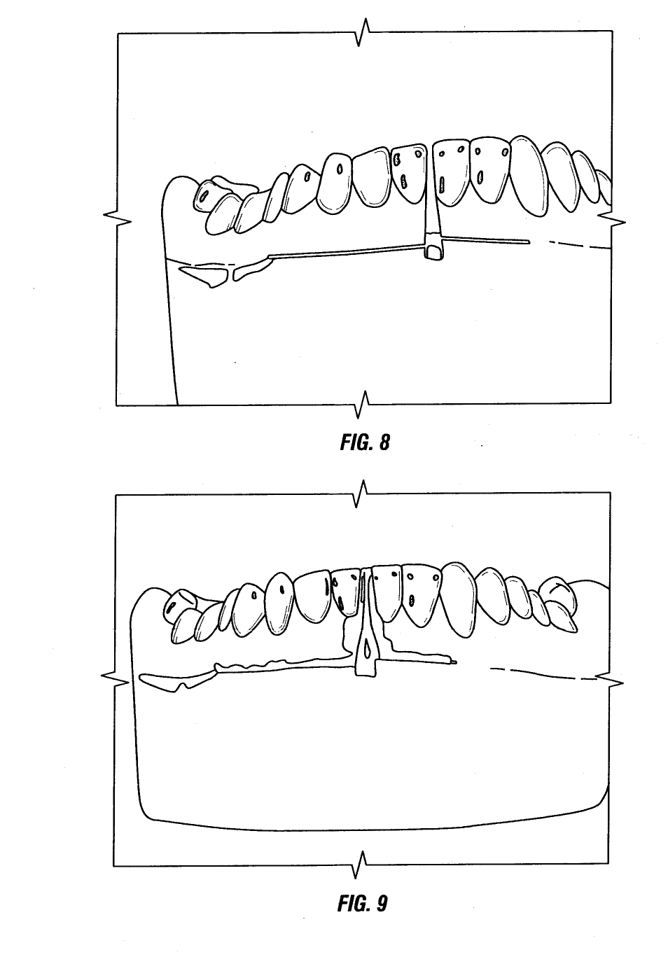

Referring now to FIGS. 8-10, there is illustrated the creation of one non-limiting embodiment of a positioner including the subject's tooth models. In FIG. 8, a positive model of the subject's teeth (as shown in FIG. 7), is cut into individual tooth models. In this example, model material below the tooth (e.g., near the gingival region) is also trimmed, to make room for the addition of wax, and to allow the tooth to move. In some embodiments, it is clear that not every tooth will be moved during treatment, or during a portion of the treatment. Thus, each individual tooth does not need to be cut from the positive model when forming the positioner; only teeth (individual teeth or groups of teeth) that will be moved are cut. During an initial analysis of the subject's dental arch, the practitioner may (roughly or more precisely) determine a treatment plan by simply observing the subject's dental arch, and estimate which teeth will need to move. As mentioned, in some embodiments teeth may be moved in “groups”; thus the teeth may be cut for placement in the positioner in groups, as illustrated.

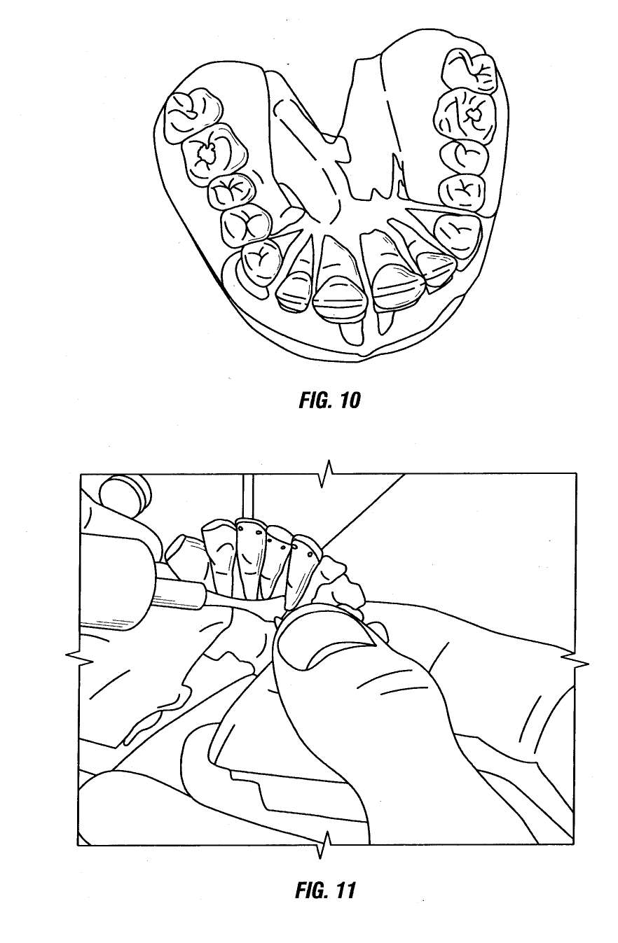

The positioner illustrated in FIGS. 8-10 is a wax positioner formed with or from the subject's initial positive dental arch model. In some embodiments, the positioner includes a separate base or tray into which the cut models of the subject's teeth are placed. In the example of FIG. 9, wax is used between the cut models of the teeth. This process may be repeated to form the positioner. As shown in FIG. 10, all of the teeth to be moved may be cut, and wax applied between them.

In some embodiments, the positioner may switch between a secured mode (in which the tooth models are held in position somewhat secured (and/or may even be ‘locked’ in position), and a movable mode, in which one or more of the tooth models may be moved within the positioner. For example, the temperature of a wax holder may be adjusted to secure the teeth in position (e.g., by lowering the temperature), or allow movement (e.g., by raising the temperature). Referring now to FIG. 11 there is shown this process for the positioner illustrated in FIGS. 8-10, in which a heated instrument is used to at least partially soften the wax around one of the tooth models to be moved. When the wax is appropriately soft, the tooth (or group of teeth) may be moved, and the wax allowed to re-harden. In some embodiments, a hardener or stiffener may be used (e.g., refrigeration, etc.).

Returning now to the embodiment of the method described in FIG. 2, the teeth may be arranged in the positioner so that they are in the patient's original tooth arrangement (step 205). The separate tooth models may be positioned within the holder using the negative impression to guide their placement. For example, the separated teeth models may be placed in the negative impression (e.g., reflecting the current arrangement of teeth in the subject's dental arch), and then applied do the positioner. Thus, the negative impression forms a template for positioning the teeth in the original arrangement (step 205).

Once the initial arrangement of the teeth is established in the positioner, the teeth may be compared against a visual reference guide 207. This comparison may be by human eye, or may be carried out partially of fully using an information handling system. A visual reference guide provides a visual reference for the position of the teeth (e.g., with respect to the other teeth, or with respect to reference markers on the guide). Thus, a visual reference guide may also be referred to as a visual reference guide. The visual reference guide may include one or more guidelines (e.g., reference lines) that provide visual reference lines for the position of teeth. For example, the visual reference guide may comprise multiple axes of reference. Thus, as non-limiting examples, the visual reference guide may comprise a grid, radial lines, concentric geometric shapes, shading/coloring, or any combination thereof. Although it is not a requirement, it may be beneficial to have the visual reference overlap (e.g., overlay or underlay) the teeth when they are placed within the positioner.

The visual reference guide may be calibrated. For example, a calibrated visual reference guide may include lines (e.g., in grid pattern) that are separated by a known distance. This calibration may allow the interpretation of changes in position. For example, the visual reference guide may comprise lines or patterns that are separated by a fraction of a millimeter (e.g., 0.1 mm, 0.2 mm, 0.5 mm), millimeters (e.g., 1 mm, 2 mm, 3 mm, 5 mm), or any other appropriate distance. A visual reference guide may also include lines that are radially separated (e.g., by a known number of degrees of arc, or fractions of degrees). The visual reference guide may marked to indicate distance or calibration. Alphanumeric markings may be used. In some embodiments, colors or symbols (or both) may be used. For example, major and minor axis marks may be indicated by different colors, corresponding to different distance increments. As described in more detail below, the visual reference guide may be adjustable.

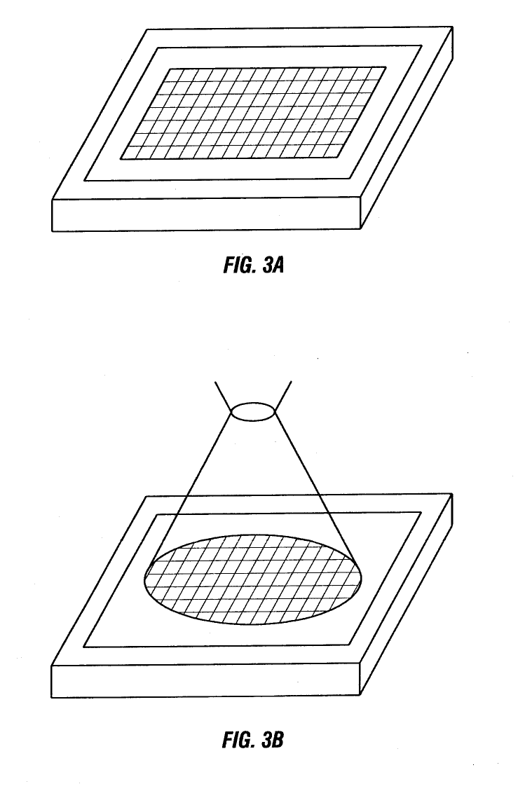

The visual reference guide may be applied to the teeth and/or holder in any appropriate manner. For example, the visual reference guide may be pre-formed (or partially pre-formed) on the positioner. Referring to FIG. 3A there is shown one non-limiting embodiment of a positioner in which a visual reference guide (shown here as a grid) is pre-formed on the positioner. The visual reference guide in FIG. 3A comprises lines that are on or within the positioner. In some embodiments, the visual reference guide is present (and may be visualized) through the wax (e.g., transparent or translucent wax) of a wax type positioner. In some embodiments, the visual reference guide is located on top of the outer surface of the visual reference guide.

In some embodiments, the visual reference guides is applied to the teeth and positioner. For example, the visual reference guide may be projected onto the teeth and positioner either permanently (e.g., marking the positioner and/or teeth), or temporarily. For example, referring to FIG. 3B, the visual reference guide may be projected by a light source and lens onto the teeth and positioner. A lens may have a visual reference guide (e.g., grid) printed on it so that it can be projected onto the teeth and positioner. Alternatively, in some embodiments, the visual reference guide is applied to the positioner and (optionally) the teeth themselves by printing or painting techniques. For example, the visual reference guide may be applied by spraying or otherwise applying a paint, ink, or other marking on the positioner and tooth models. In some embodiments, the visual reference guide may be laser applied. For example, a laser may be used to write the visual reference guide on the positioner and tooth models. In some embodiments a laser may ‘burn’ the reference guide onto the positioner (and optionally, the tooth models). In some embodiments, the positioner may be coated with a sintering material or a photosensitive material that can be “written” by applying the appropriate wavelength and/or intensity of light.

It may be beneficial (although not necessary) to apply the visual reference guide to the tooth models as well as the positioner. In some embodiments, the tooth models my also (or alternatively) be marked to more easily allow their movement to be tracked with respect to the visual reference guide. For example, the tooth models may be marked with lines as part of the same pattern as the visual reference guide. In some embodiments, the tooth models may be marked with a crosshair, dot(s), or other indicator.

The visual reference guide may also be applied only to an image of the tooth models and positioner. Thus, one or more image capture devices (cameras, video recorders, as non-limiting examples) may be used to show both the tooth models and the visual reference guide. The visual reference guide is overlaid onto the image of the tooth models in the positioner by the camera. Multiple image capture devices can be used to show different perspectives. Different (or related) visual reference guides may be used for each image. The tooth models may still be marked (with identifying marks) when a visual reference guide is overlaid onto an image of the tooth models. Marking may help track and visualize the movements of the tooth models in the positioner. The image capture device(s) used may also allow the magnification of the images of the tooth models. Thus the movements of the tooth models may be more readily visualized and controlled by referring to the image of the tooth models and the visual reference guide.

In some embodiments, the visual reference guide may be adjustable or scalable. At least one of the dimensions of the visual reference guide may resized or resealed. As a non-limiting example, for a rectangular grid, the x-axis and/or y axis may be resized or rescaled. For example, when the visual reference guide is overlaid onto images of the tooth models, an information handling device (computer or controller, may be used control the application of the visual reference guide, and the computer or controller may be used to adjust the scale. A visual reference guide may be set based on the initial position of the tooth models. For example, the visual reference guide may include a radial or linear coordinate centered on each tooth model. In addition, any type of suitable information handling device data input peripheral may also be used to adjust the type or shape of the visual reference guide. In some non-limiting embodiments, the visual reference guide can be “moved” or adjusted by use of an input device comprising or incorporating one or more of a controller, mouse, touch pad, touch screen, joystick, keyboard, voice recognition system, retinal tracking, haptic devices, wired glove, devices incorporating accelerometer and optical sensor technology, wheels, rollers, triggers, or any other user-input device to move or adjust the visual reference guide. As described in greater detail below, an information handling system (most likely a computer or controller) may also be used to monitor or track the movements of the teeth and/or provide feedback as the tooth models are manually moved.

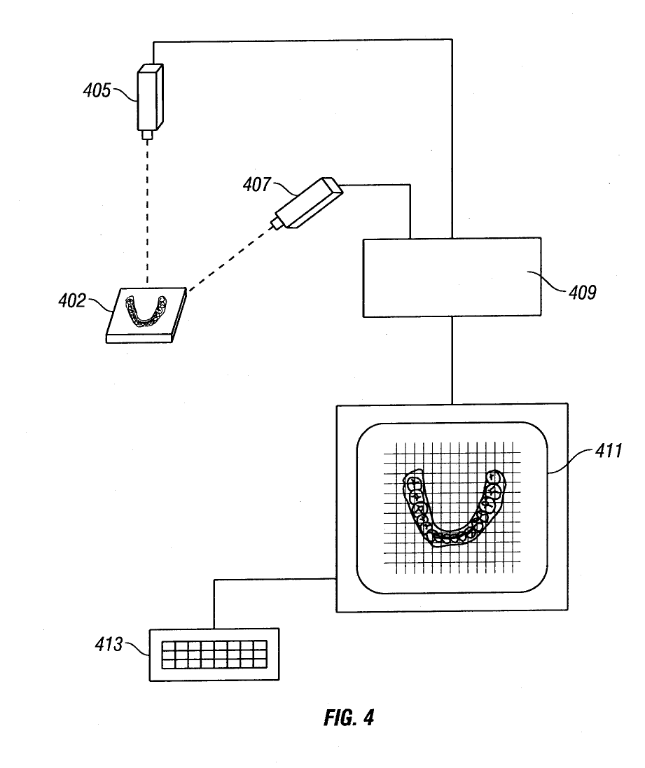

Referring now to FIG. 4 there is illustrated one non-limiting embodiment of a system for making a series of dental models, in which at least two image capture device 405 and 407 are used to visualize the tooth models within a positioner 402. Thus, images from at least one of the image capture devices may be viewed with an image output device 411 (non-limiting examples of which include screens, monitors, displays, projectors, or printers) shown as a display in the embodiment of FIG. 4. Although this example shows two different cameras, oriented with different perspectives, any number, including only one, or more than two cameras may be used. In this example, the cameras are fixed in position, relative to the positioner, however in some embodiments the relative positions of the cameras and the positioner may be moveable, that is, the positioner may be moveable and/or at least one of the cameras is moveable. In the non-limiting embodiment shown in FIG. 4, the visual reference guide is shown as a grid that is applied to the image. As mentioned previously, the visual reference guide may alternatively (or additionally) be actually present on the positioner and/or teeth.

The different views provided by multiple image capture devices may more readily allow estimation of movement of the tooth in any physical dimension. For example, the tooth models may be viewed from above, and from one or more side angles. Each view may be observed via a different image, and may have a different visual reference guide (each of which may be calibrated).

An information handling device 409 may be used to control the view of the image handling devices, and/or to track the movement of tooth models as they are manually moved. For example, an information handling system may control the magnification or focus of the image shown on the display 411. An input device 413 (shown here as a keyboard, although any appropriate input device may be used) may be used to provide input and comments or annotations to the information handling device 409, image handling devices 405, 407 and/or the display 411. For example the input device may be used to toggle between different views of the tooth models and visual reference guide. In some embodiments, an input may be used to mark one or more tooth models or to draw a measuring line to estimate movement of a tooth model.

Returning now to FIG. 2, in one exemplary method for making a series of dental models, the teeth may be incrementally moved while using the visual reference guide to track the movements (step 209). In general, movements are all made manually, by a technician (or other appropriate practitioner) viewing the tooth models and visual reference guide. With the digital dental models, the manual movements may be made by moving the digital tooth with a mouse or other such input device.

The visual reference guide provides a technician with visual feedback on tooth movement. Movement may be in translation (e.g., x or y in the plane of the dental arch), in rotation (e.g., including rotation the tooth model in the long axis, perpendicular to the xy axis), and in tilt (e.g., changing the angle with respect to the xy axis). In particular, when the visual reference guide is calibrated, the technician may know how far the movement has occurred.

In some embodiments, manual movements may be guided or aided by an information handling system tracking the tooth movements. For example, information handling system 409 may receive visual images of the teeth and may be used to approximate the extent of movement. In some embodiments, the practitioner viewing an image of the tooth models and the visual reference guide may take snap shots of the image before and after a movement, and use these images to measure the change in position of the tooth. For example, a cursor may be placed on the tooth or a mark on the tooth in both the before and after images (after movement of one or more tooth). The distance of movement may be estimated from the calibration of the visual reference guide. When the movement exceeds some threshold value (e.g., greater than an allowable “incremental movement” (e.g. 0.2 mm), the information handling system may indicate that the tooth has been moved too far. Images of the tooth models may be shown overlapping (simultaneously), or side-by-side. The calculation of movement may be done automatically (e.g., by detecting a mark or marker on the tooth model), manually (by dropping a cursor), or semi-automatically. Thus, an information handling system may be used to track movement of the tooth models, and may help indicate allowable or non-allowable movements.

The information handling system may also provide feedback beyond simply displaying the tooth models and the visual reference guide. For example, the information handling system may indicate that a certain movement has exceeded an allowable parameter. Feedback may be visual feedback (non-limiting examples include warning text; color; and, blinking, flashing, rotating, shaking and/or vibrating image), auditory feedback (non-limiting examples of which include one or more beep, continuous tone, alternating tone, increasing stone), touch feedback (non-limiting example of which include vibrations by the mouse), or the like. Feedback may be toggled on/off. For example, it may be desirable to move the teeth manually using the visual reference guide. In some embodiments, feedback may be an indication of the amount of movement of one or more tooth models. The feedback may be increasing and/or decreasing as the tooth is closer and or farther away from the desired position. As a non-limiting example, a beeping tone will slow done the closer to the target position, and will increase farther away from the target position. Thus, the information handling system may indicate on an image of the tooth models and visual reference guide how far a certain tooth has moved. The information handling system may also allow the technician to save images, and to record information about the images (including numbering the sequence of the images, and indicating (e.g., by drawing on the image or adding or appending text or other information to the image) the movements of the teeth.

In some embodiments, the visual feedback, which may be coupled with auditory and/or touch feedback, may indicate when the tooth has been properly positioned. For example, the practitioner may indicate where the tooth should be manually moved on the visual reference guide on the computer. When manually moving the tooth (or teeth), the image of the tooth on the visual reference guide may indicate when the tooth or teeth have been moved as desired. For example, the image may change color, flash, or disappear (i.e., the image of the tooth/teeth being moved). Thus, the computer may guide the movement. Thus, in some embodiments, the practitioner uses the visual reference guide to observe the tooth or teeth, and set a marker (or makers) on the visual reference guide with which the actual image of the teeth model (in the positioner) may be aligned.

Images showing the movements of the teeth may also be recorded. In some embodiments, the tooth movements may be tracked by storing images taken after completion of the movement to a desired position, without regard for taking any images of the tooth during its journey to the desired position. In other embodiments, the tooth movements may be tracked by storing images taken during the journey to the desired position, as well as images at the desired position. Images tracking the movement of the tooth models may be stored digitally (e.g., on information handling system-readable media) or in analog (e.g., videotape, etc.). Image capture may be by single images taken as screen shots or photographs, and/or by a sequence of still images representing scenes in motion (whether stored digitally or on tape). Movements may also be recorded by recording the location of the teeth (or a marker on the tooth models) with respect to one or more of the visual reference guide(s). The movements of the tooth models may also be manually recorded. In embodiments having multiple views of the tooth models, images of each of the views may be saved. Movements may be indicated on hardcopy or a computer representation of the visual reference guide, or movements may be extracted from images of the tooth models after each movement. The settings used may also be recorded. For example, the orientation and calibration of the visual reference guide may be recorded, the magnification used, etc. This information may be helpful in revising the series of dental models, or replicating the series.

A record of movements may include symbolic information (non-limiting examples of which include written instructions, descriptions, symbols, codes) indicating movements or other tooth modifications (e.g., including modifications to the shape or size of the teeth or addition of elements such as engagers). In general, a written record is preferred. A written record is typically a record describing the tooth movements and/or modifications. Non-visual records may be more generally understood, and may take less room to save. The written record may include graphic (i.e., non-animated graphics), numeric, alphabetic, or symbolic descriptors. For example, a written record may describe the movement of specific teeth by name (e.g., molars, incisors, etc.), or by location and/or number (e.g., upper right 3), the movement of that tooth or group of teeth (e.g., rotation, translation, etc.), the direction of movement (e.g., lingual/distal) and the amount of movement (e.g., in any appropriate units, such as mm). The record of tooth movements may be made as the movements to the teeth in the positioner are made (e.g., ongoing) or it may be made after movements have been made (post-treatment, or partially through treatment). As mentioned above, the record may also indicate modifications of the teeth to be made at various stages of treatment. For example, the record may indicate reduction (e.g., interproximal reduction) or one or more teeth, or the including of an additional element (e.g., an engager).

As mentioned above, movements of the tooth models should be incremental. In general, the movement of individual teeth may be constrained to a small (incremental) distance, tilt or rotation. Thus, a series of tooth models can span a dramatic change in the arrangement of teeth, but include numerous tooth models. Tooth models having incremental changes in tooth position are particularly useful when investigating or producing dental appliances (including but not limited to dental aligners), because a subject's teeth may be moved only by incremental amounts between treatment steps. As discussed briefly above, a information handling system may track the manual tooth movements, and may provide feedback to the technician moving the teeth. Thus, in some embodiments the information handling system may indicate when a movement has exceeded a predetermined amount in a given direction. For example, when the translational movement of a tooth has exceeded 0.2 mm.

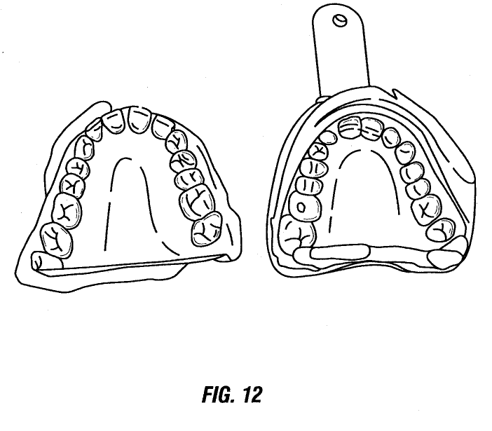

Once the incremental movements have been made, and the tooth models are placed in the new arrangement, a model of the new arrangement should be taken. For example, a dental impression of the teeth in the new position may be taken (step 211). Thus, a cast or imprint may be made from the new arrangement of the tooth models. In embodiments in which the positioner is lockable (or can be secured), the tooth models may first be secured into position so that the impression can be made. Once the negative impression has been taken, a model of the dental arch may be made by casting a positive model from the negative impression. A non-limiting example of this is illustrated in FIG. 12.

As described in FIG. 2, the steps above may be repeated as necessary to produce additional dental models in the series. Typically, the last dental model (after the incremental changes) is the starting point for the next model. Thus, the initial configuration of the teeth may be taken as the most recently created model in the series. In cases where the teeth have been moved from their position (either accidentally, or because it is desirable to redo one or a number of dental models in the series), the negative impression taken of last set of dental models in the series (before the new model is created) may be used to position the teeth as described in step 205. The method can be repeated until the teeth have been incrementally moved into a desired final position, which is represented as the final tooth model.

Apparatus for the production of dental arch models may include at least one of the elements described above, and shown in FIG. 4. For example, a system for making dental arch models may include a positioner configured to hold an arrangement of tooth models and to permit manual movement of the tooth models, as described. The system may also include an image capture system configured to view the arrangement of tooth models within the positioner. The image capture system may be mounted so that it is fixed with respect to the positioner, or it may be movable. For example, the image capture system may be focused down onto the positioner. Any appropriate image capture device may be used, non-limiting examples of which include digital cameras (e.g., CCD, CMOS, etc.). The apparatus may also include an image output device that is configured to output an image of the arrangement of tooth models viewed by the image capture device. Where multiple image capture devices are used as part of the system, the a single display may be used (that can either simultaneously or selectively display the different views). Any of the visual reference guides described herein may be used. For example, a visual reference guide may be applied to the image of the tooth models taken with the image capture device(s). The visual reference guide is typically configured to track movements of teeth within the positioner, and may be calibrated, as described above. The system may also include an information handling system that controls the visual reference guide and/or the image capture devices (e.g., focus, storing or recording images or video, etc.). The information handling system may also include an input that allows a technician to annotate the images, and may allow for movements of the tooth models to be measured. Finally the information handling system may be configured to track the movements of the tooth models and to provide feedback of the movements.

In non-limiting embodiments, part or all of the methods described herein may be described as instructions for an information handling system, and stored on one or more computer readable media or transmitted by a propagated signal. In other non-limiting embodiments, the computer readable media may be incorporated into information handling systems.

Portions of the present disclosure, detailed description and claims may be presented in terms of logic, software or software implemented aspects typically encoded on a variety of media including, but not limited to, computer-readable media, machine-readable media, program storage media or computer program product. Such media may be handled, read, sensed and/or interpreted by an information handling system. Those skilled in the art will appreciate that such media may take various forms such as cards, tapes, magnetic disks (e.g., floppy disk or hard drive) and optical disks (e.g., compact disk read only memory (“CD-ROM”) or digital versatile disc (“DVD”)). It should be understood that the given implementations are illustrative only and shall not limit the present disclosure. Embodied on a computer-readable medium may be a data structure. As used herein, a data structure may be a physical or logical relationship containing data elements and/or information.

As mentioned briefly above, the dental models may be marked to indicate their order or sequence in the series of models. For example, in general, one or more of the teeth in each dental model are moved incrementally compared to the position of the teeth in the earlier dental model in the series. Thus, the dental models may be marked to indicate the progression of teeth as they are moved. For example, the first dental model in the series may represent the actual position of the subject's teeth or a projected starting point for future treatment, and may be marked or imbedded with a tag, symbol, number, letter, character, color, phrase, barcode, indicator or the like, to indicate this, and additional dental models may be marked to indicate their position in the series. A marking or identification may be applied to the model, it may be attached to the model (e.g., as a tag, etc.), may be imbedded and detectable (as a non-limiting example, an RFID tag), or indicia may be provided on the packaging of the model. For example, the marking may be written (printed, painted, etc.) onto the model, or it may be carved or impressed into the model. The marking may be visible or not visible. For example, models may be marked with radiolabels or the ink that is visible only when exposed to a specific wavelength of light. In some embodiments, the markings may be placed on a bottom surface (away from the crown region of the teeth). In other embodiments, the markings may be made on an upper surface of the teeth. In even other embodiments, the indicator may be an emitted sound (which may or may not be in the range of the human ear), a radio frequency, and/or an environmentally safe radioactive marker.

After some number of dental models have been produced as described above, they may be grouped into a set. At some point, this set may be provided to a distributor, retailer, or dental practitioner. In particular, models may be provided to the practitioner that provided the dental impression from which the initial dental model was formed. An entire series of dental models may be sent, or a subset of the dental models may be sent. For example, dental models in a series may be sent one at a time to a practitioner. In some embodiments, dental models in a series may be sent two at a time, three at time, four at a time, etc. In some embodiments, all of the dental models may be sent at once. Dental models may be marked before sending, or they maybe sent unmarked.

In addition (or alternatively) to sending models, the practitioner may be sent images or pictures of the dental model (including images of the separate tooth models arranged in the positioner, from which the models are made). Multiple images corresponding to each dental model may be sent. Images of only one dental model (e.g., the last or final dental model in the series) may be sent, or subsets of the dental models may be sent.

In addition to the models and/or images of the models, a record of the movements of the teeth in the entire (or a subset of the) series of dental models may be sent. For example, a written or graphical representation of the movements of each tooth may be included. The record of tooth movements may be electronic. In some embodiments, the movement of an individual tooth (or group of teeth) may be shown or described. In other embodiments, all (or some) of the tooth movements may be shown or described.

The dental models may be prepackaged before being provided to a practitioner. For example, dental models maybe placed in a container configured to fit the dental model, and to prevent breakage of the dental model. In some embodiments, the packaging includes packing material (e.g., foam, insulation, etc.) to prevent breakage. In some embodiments, the dental models are adapted to be securely held in the packaging. For example, the packaging may include a portion that securely mates with the base of the dental model. In some embodiments, multiple dental models (or an entire series of dental models) may be secured within the same packaging.

Once the practitioner has received all or a subset of the models (and/or optionally images of the dental models and/or a record of the movements of the teeth in the series of dental models), the practitioner may provide comments and feedback to modify the series of dental models. For example, if the intermediate or final dental models in the series are not satisfactory (e.g., the teeth have not been moved far enough, or in the correct positions), the practitioner may indicate how he or she would prefer to have the teeth moved. For example, the images of the teeth may be marked up, or the record of tooth movements may be marked up, or the model itself may be marked up. In some embodiments, written instructions or directions are provided by the practitioner describing how the practitioner would like the teeth to be moved or positioned. The practitioner may send the comments to the technician so that the series of dental models may be modified. As described briefly above, the series may be modified by using the record of tooth movements (recorded using the visual reference guide) to return to any of the series of dental models and modify the movements of the teeth without having to start completely over.

As mentioned briefly above, a series of dental models may be used to produce dental appliances, particularly appliances intended to move a subject's teeth to a desired position, such as the positions shown by the series of dental models. Dental aligners are one type of dental appliance that may be made using a series of dental models having incremental movements of the teeth described herein. Aligners (or trays) may be formed by fitting a compliant (e.g., polymeric) material over a positive model of the dental arch in which teeth have been incrementally moved. Non-limiting examples of dental aligners, and methods of fabricating them, are provided in U.S. Pat. No. 6,722,880, U.S. Pat. No. 7,037,111, U.S. Pat. No. 6,210,162, U.S. Pat. No. 6,217,325, U.S. Pat. No. 6,227,851, U.S. Pat. No. 6,309,215, U.S. Pat. No. 6,499,997, U.S. Pat. No. 6,629,840, U.S. Pat. No. 6,685,469, U.S. Pat. No. 6,964,564, and U.S. Pat. No. 7,092,784, each of which is herein incorporated by reference in its entirety.

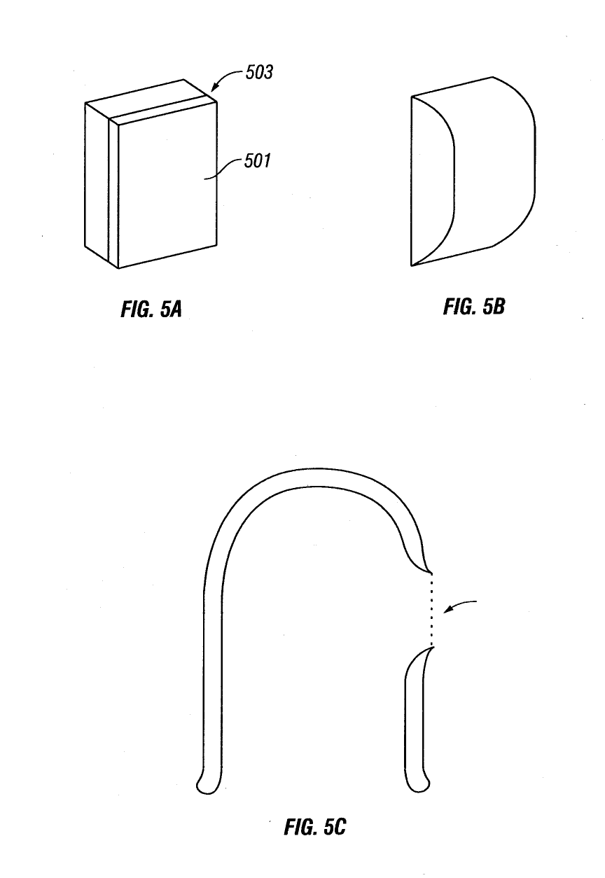

It may also be desirable to include one or more attachments on the teeth to which dental appliance may be anchored or connected, to help in moving the teeth. Some embodiments of attachments are described in U.S. Pat. No. 6,705,863, U.S. Pat. No. 6,830,450, U.S. Pat. No. 6,309,215, U.S. Pat. No. 6,390,812, and U.S. Pat. No. 6,485,298, which is also herein incorporated by reference in its entirety. Referring now to FIG. 5A, there is shown an additional example of one embodiment of an engager 501 that may be used to secure an aligner to a subject's teeth. Typically, an engager is secured to the tooth (e.g., by cementing, etc.), and is configured to engage with a region (or regions) of the aligner, enhancing the ability of the aligner to secure to, and move, the teeth.

The engager 501 shown in FIG. 5A has a slight groove 503 around one edge. In practice, the engager may be bonded to the teeth, so that the grooved edge is an upper edge (extending 3-4 mm). The grooved edge may engage with the aligner. The groove may extend around the upper edge and/or top of the engager. Generally, these engagers may be prefabricated and bonded to the teeth. In some embodiments the sides of the engager 501 are curved or rounded, as shown in FIG. 5B. This rounded edge may enhance comfort and may also strengthen the connection between the tooth/engager and the aligner, tray or other dental appliance with which the engager couples. For example, a tray having a cut-out region for mating with an engager is illustrated in FIG. 5C. In this figure, the tray (or aligner) includes a cut-out region having curved sides. The engager may fit into the cut-out region, and the curved sides of the cut-out region strengthen the cut-out region. In some embodiments, cut-out regions having curved sides may be used with engagers that do not have curved sides.

The specification and drawings illustrate by way of example, not by way of limitation, the principles of some embodiments of the methods and apparatus of the invention. Descriptions of specific materials, techniques, and applications are provide d only as examples. Various modifications to the examples described herein will be readily apparent to those of ordinary skill in the art, and the general principles defined herein may be applied to other examples and applications without departing from the spirit and scope of the invention. Thus, the claims of the present invention are not intended to be limited to the examples described and shown, but is to be accorded a scope consistent with the appended claims.

The apparatus and methods of the present invention have described and illustrated by examples. While these apparatus and methods have been described in terms of particular embodiments and illustrative figures, one of ordinary skill in the art will recognize that the invention and the appended claims are not limited to the embodiments or figures described. In addition, where methods and steps described above indicate certain events occurring in certain order, those of skill in the art will recognize that the ordering of certain steps may be modified and that such modifications are in accordance with the invention, and embodiments of the invention. Additionally, certain of the steps may be performed concurrently or in parallel processes when possible, as well as performed sequentially, as described above. Thus, to the extent that there are embodiments of the invention, which are within the spirit of the disclosure or equivalent to the inventions found in the claims, it is intended that the patent will cover those embodiments as well. Finally, all publications, patents and patent applications cited in this specification are herein incorporated by reference in their entirety as if each individual reference was specifically and individually set forth herein.

What is claimed is:

1. A method of making a series of dental models comprising:
positioning tooth models within a positioner in a first tooth arrangement; and,
manually moving one or more of the tooth models with reference to a visual reference guide, to position the tooth models within the positioner in a second tooth arrangement.

2. The method of claim 1, wherein the dental models are physical dental models, and further comprising:
forming a negative impression of the teeth in the second tooth arrangement; and
forming a positive model Of the second tooth arrangement.

3. The method of claim 1, wherein the visual reference guide comprises at least one of rectangular grid lines, radial lines, and concentric geometric shapes.

4. The method of claim 1, wherein the positioner comprises a wax holder.

5. The method of claim 1, further comprising:
forming the tooth models by cutting a positive model of the dental arch into separate tooth models.

6. The method of claim 1, wherein positioning the tooth models in a first tooth arrangement comprises using a negative impression of the subject's dental arch to position the tooth models in the positioner into the first tooth arrangement.

7. The method of claim 1, wherein viewing the tooth models with a visual reference guide comprises viewing the tooth models using a camera to form an image of the first tooth arrangement.

8. The method of claim 7, further comprising overlaying the visual reference guide onto the image of the first tooth arrangement.

9. The method of claim 8, further comprising tracking the movement of the tooth models with respect to the visual reference guide.

10. The method of claim 9, wherein the step of tracking the movement comprises tracking recording the movement of the tooth models using a digital device.

11. The method of claim 1, further comprising providing feedback on the manual movements of the tooth models.

12. The method of claim 11, wherein a computer provides feedback on the manual movement of the tooth models based on the visual reference guide.

13. A system for producing a series of dental models, comprising:
a positioner configured to hold an arrangement of tooth models and permit manual movement of the tooth models;
a camera configured to view the arrangement of tooth models within the positioner;
a display configured to display an image of the arrangement of tooth models viewed by the camera; and
a visual reference guide configured to track movements of teeth within the positioner.

14. The system of claim 13, wherein the visual reference guide is configured to appear on the display of the image of the arrangement of tooth models viewed by the camera.

15. The system of claim 13 wherein the visual reference guide comprises at least one of rectangular grid lines, radial lines, and concentric geometric shapes.

16. The system of claim 13, further comprising a recorder configured to record movements of the teeth within the positioner.

17. The system of claim 16, wherein the recorder comprises a computer.

18. The system of claim 13, further comprising a computer configured to track the movements of the teeth using the visual reference guide.

19. A system for producing a series of dental models, comprising:
a positioner for holding an arrangement of tooth models;
a plurality of cameras configured to view the arrangement of tooth models within the positioner;
a display configured to display an image of the arrangement of tooth models viewed by at least one of the cameras; and
a visual reference guide applied to the image of the arrangement of the tooth models, the visual reference guide configured to track manual movements of teeth within the positioner.

20. The system of claim 19, further comprising a computer configured to track movement of the tooth models using the movement guide and further configured to provide feedback on manual movement of the tooth models.

21. A method of providing a series of positive dental models, comprising:
producing a series of dental models comprising at least a first dental model, a second dental model, and a third dental model,
wherein the dental models represent at least a portion of a subject's dental arch, and
wherein at least one tooth in the second dental model is in an incrementally different position in the first dental model, and further
wherein at least one tooth in the third dental model is in an incrementally different position in the second dental model; and
delivering the series of dental models to a dental practitioner.

22. The method of claim 21, wherein the series of dental models comprise polyurethane models of the subject's teeth.

23. The method of claim 21, further comprising marking the models in the series of dental arch models to indicate the sequential order of a model within the series of dental arch models.

24. The method of claim 21, further comprising delivering a written record of the movements indicating the difference in positions between teeth in the series of dental models.

25. The method of claim 21, wherein the step of producing a series of dental models comprises:
positioning tooth models within a positioner;
sequentially forming positive dental arch models by manually moving one or more of the tooth models in the positioner with reference to a visual reference guide into a tooth arrangement and making a positive dental arch model of the tooth arrangement.

26. A method of providing a series of positive dental models, comprising:
receiving a model of a subject's dental arch from a dental practitioner;
producing a series of positive dental models comprising at least a first dental model, a second dental model, and a third dental model,
wherein at least one tooth in the first dental model is in an incrementally different position than the corresponding tooth in the model of the subject's dental arch received from the practitioner, and
wherein at least one tooth in the second dental model is in an incrementally different position in the first dental model, and further
wherein at least one tooth in the third dental model is in an incrementally different position in the second dental model; and
delivering the series of dental models to the dental practitioner.

27. The method of claim 26, wherein the series of dental models comprise polyurethane models of the subject's teeth.

28. The method of claim 26, further comprising marking the series of dental arch models to indicate the sequential order of the models within the series of dental arch models.

29. The method of claim 26, further comprising delivering a written record of tooth movements indicating the movement of teeth within the series of dental models.

30. The method of claim 26, wherein the step of producing a series of dental models comprises:
separating a positive model of the subject's dental arch into separate tooth models;
positioning the tooth models within a positioner;
sequentially forming positive dental arch models by manually moving one or more of the tooth models in the positioner with reference to a visual reference guide; and
making a positive dental arch model of the teeth after moving them.
